(19) United States
(12) Patent Application Publication
(10) Pub. No.: US 2024/0334525 A1
(43) Pub. Date: Oct. 3, 2024

(54) ACCESS NETWORK DEVICE, TERMINAL DEVICE, AND CORE NETWORK DEVICE

(71) Applicant: GUANGDONG OPPO MOBILE TELECOMMUNICATIONS CORP., LTD., Dongguan (CN)

(72) Inventors: Jingran CHEN, Dongguan (CN); Fei LU, Dongguan (CN)

(21) Appl. No.: 18/740,199

(22) Filed: Jun. 11, 2024

Related U.S. Application Data
(63) Continuation of application No. PCT/CN2021/139376, filed on Dec. 17, 2021.

(51) Int. Cl. H04W 76/19; H04W 76/20; H04W 84/06

(52) U.S. Cl. CPC H04W 76/19; H04W 76/20; H04W 84/06

(57) ABSTRACT

Provided is an access network device. The access network device is integrated on a satellite and includes a processor. The processor is configured to resume a connection with a second device in a case that a first device is unreachable, wherein the first device is a terminal device, and the second device is a core network device, or, the first device is a core network device, and the second device is a terminal device.

### CROSS-REFERENCE TO RELATED APPLICATION

This application is a continuation of International Application No. PCT/CN2021/139376, filed Dec. 17, 2021, the entire disclosure of which is incorporated herein by reference.

### TECHNICAL FIELD

Embodiments of the present disclosure relate to the field of communication technologies, in particular, relate to an access network device, a terminal device, and a core network device.

### BACKGROUND

Regenerative forwarding refers to satellites having some or all of the functions of access network devices. Satellites have signal store and forward capabilities, enabling non-geostationary synchronous orbit (NGSO) satellites to provide service coverage to regions where ground gateway stations cannot be deployed.

For example, for Internet of Things (IoT) terminal devices in remote ocean areas where ground gateway stations cannot be deployed, NGSO satellites cannot provide end-to-end connections for such terminal devices, and as a result, the terminal devices fail to maintain a constant connection to the network. There are scenarios where only terminal devices are connected to satellites, and only satellites are connected to core network devices. In such situations, how to transmit data is an urgent problem to be solved.

### SUMMARY

Embodiments of the present disclosure provide an access network device, a terminal device, and a core network device. The technical solutions are as follows.

According to some embodiments of the present disclosure, an access network device is provided. The access network device is integrated on a satellite and includes a processor; wherein the processor is configured to resume a connection with a second device in the case that a first device is unreachable, wherein the first device is a terminal device, and the second device is a core network device, or, the first device is a core network device, and the second device is a terminal device.

According to some embodiments of the present disclosure, a terminal device is provided. The terminal device includes a processor, wherein the processor is configured to resume an RRC connection with an access network device in the case that a core network device is unreachable by the access network device, wherein the access network device is integrated on a satellite.

According to some embodiments of the present disclosure, a core network device is provided. The core network device includes a processor, wherein the processor is configured to resume an N3 connection of a PDU session with an access network device in the case that a terminal device is unreachable by the access network device, wherein the access network device is integrated on a satellite.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of the user plane optimized connection suspend process according to some embodiments of the present disclosure;

FIG. 2 is a flowchart of the connection resume process under a CM-IDLE state according to some embodiments of the present disclosure;

FIG. 3 is a schematic diagram of a communication system according to some embodiments of the present disclosure;

FIG. 4 is a schematic diagram of a network architecture according to some embodiments of the present disclosure;

FIG. 5 is a flowchart of a method for transmitting data according to some embodiments of the present disclosure;

FIG. 6 is a flowchart of a method for transmitting data according to some embodiments of the present disclosure;

FIG. 7 is a flowchart of a method for transmitting data according to some embodiments of the present disclosure;

FIG. 8 is a block diagram of an apparatus for transmitting data according to some embodiments of the present disclosure;

FIG. 9 is a block diagram of an apparatus for transmitting data according to some embodiments of the present disclosure;

FIG. 10 is a block diagram of an apparatus for transmitting data according to some embodiments of the present disclosure; and

FIG. 11 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings.

The network architecture and service scenarios described in the embodiments of the present disclosure are intended to describe the technical solutions in the embodiments of the present disclosure more clearly, but do not constitute a limitation on the technical solutions according to the embodiments of the present disclosure. Those of ordinary skilled in the art learn that, with the evolution of the network architecture and the emergence of new service scenarios, the technical solutions according to the embodiments of the present disclosure are also applicable to similar technical problems.

Before the technical solutions of the present disclosure are detailed, some technical knowledge involved in the present disclosure is first explained.

### Non-Terrestrial Network (NTN) Technology

Currently, relevant standard organizations are researching the NTN technology, which generally provides communication services to ground users over satellite communication. Compared to ground-based cellular communication networks, satellite communication has many unique advantages. Firstly, satellite communication is not restricted by user locations. For example, typical terrestrial communications cannot cover areas such as oceans, mountains, and deserts where communication devices cannot be installed, or regions where communication coverage is not available due to sparse population. However, for satellite communication, since a single satellite covers large ground areas and orbits the earth, theoretically, every corner of the earth can be covered by satellite communication. Secondly, satellite communication has significant social value. Satellite communication covers remote mountainous areas, poor and underdeveloped countries or regions at a lower cost, allowing people in these areas to enjoy advanced voice communication and mobile internet technology. This helps bridge the gap with developed areas in accessing the digital technology and resources and promotes development in these areas. Thirdly, satellite communication features a longer communication distance, and increasing communication distance does not significantly increase communication costs. Lastly, satellite communication is highly stable and not restricted by natural disasters.

Communication satellites are categorized based on their orbital altitude into different types such as low-earth orbit (LEO) satellites, medium-earth orbit (MEO) satellites, geostationary earth orbit (GEO) satellites, high elliptical orbit (HEO) satellites, or the like. Currently, the main focus of research is on LEO and GEO satellites.

### 1. LEO

The altitude of the LEO satellite ranges from 500 km to 1500 km, with a corresponding orbital period ranging from approximately 1.5 to 2 hours. The signal propagation latency for single-hop communication between users is generally less than 20 ms. The maximum satellite visibility time is around 20 minutes. The signal propagation distance is short, with fewer link losses, and low requirements for transmit power at user terminal devices.

### 2. GEO

Geostationary earth orbit satellites have an orbit altitude of 35786 km and a rotation period around the earth of 24 hours. The signal propagation latency for single-hop communication between users is generally 250 ms.

To ensure satellite coverage and increase the overall system capacity of the satellite communication system, satellites use multiple beams to cover the ground, and one satellite may form dozens or even hundreds of beams to cover the ground; and one satellite beam may cover a ground area with a diameter ranging from tens to hundreds of kilometers.

### Store and Forward Scenario of Satellites in Regenerative Forwarding Mode

Regenerative forwarding refers to satellites having partial or complete functionalities of access network devices. Satellites have signal store and forward capabilities, enabling non-geostationary synchronous orbit satellites to provide service coverage to regions where ground gateway stations cannot be deployed. For example, for IoT terminals in remote ocean areas where ground gateway stations cannot be deployed, non-geostationary synchronous orbit satellites cannot provide end-to-end connections for such user equipments (UEs), ensuring continuous communication between the UE and the network for a period. However, because most of the data that the IoT device needs to transmit is tolerant of high latency, for uplink data, the satellite, when covering such a UE, collects UE data for storage and activates a feeder link to forward the data to the core network device when the satellite is connected to the core network device. For downlink data, the core network device transmits the data to the satellite for storage first, and when traveling over the area covering the UE, the satellite transmits the data to the UE.

### High-Latency Communication (HLCOM)

HLCOM mainly targets terminal devices using power-saving functions. In the case that there is downlink data to be transmitted in the network but the terminal device is unreachable due to being in a power-saving state, the network effectively handles downlink data of latency-tolerant services, thereby avoiding unnecessary data transmission.

The session management function (SMF) in the access network (AN) release process uses data forwarding action rules and user data buffering action rules to configure the user plane function (UPF) of an anchor. These rules indicate whether the UPF should buffer data or transmit data to the SMF, which then buffers the data. Upon receiving downlink data from a terminal device (i.e., UE), the SMF determines whether to activate the buffer function based on the configuration and indicates the access and mobility management function (AMF). Upon receiving indications from the SMF, in the case that the UE is unreachable due to power saving, the AMF instructs the SMF to buffer the data and provides the longest waiting time to the SMF based on power-saving-related parameters. The SMF determines the extended buffer time based on local configuration and the waiting time transmitted by the AMF.

### User Plane Optimized Connection Suspend Process

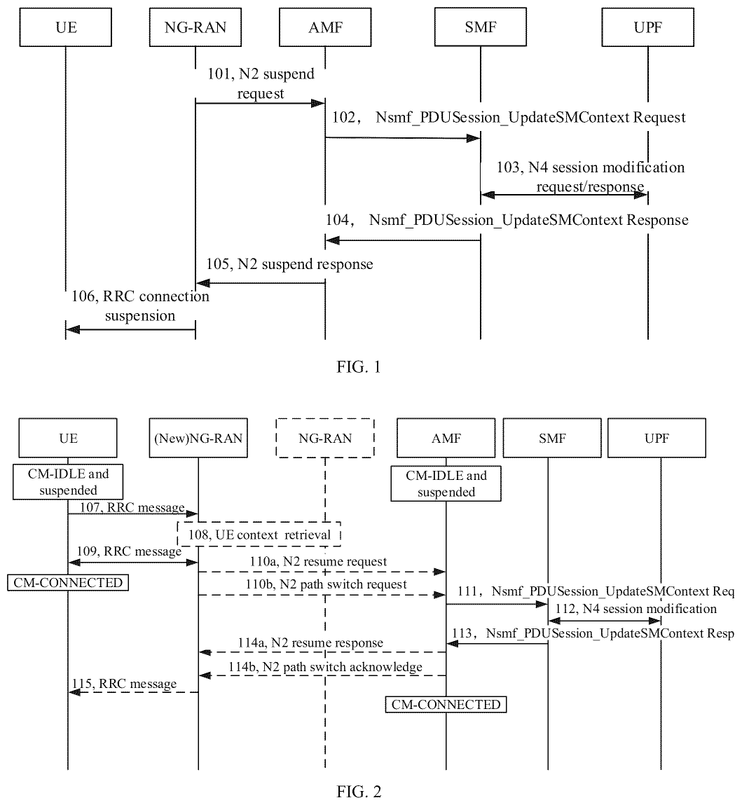

Next generation-radio access network (NG-RAN) maintains the UE context even when the UE transitions to an idle (IDLE) state, such that the UE transmits data in the IDLE state without needing to reestablish user plane bearers and security context between NG-RAN and UE using the service request process. The user plane optimized connection suspend process is shown in FIG. 1, and the method includes the following processes.

In process 101, the NG-RAN transmits an N2 suspend request message to the AMF to trigger the connection suspend process. The AMF enters the connection management CM-IDLE state and records that the UE's connection has been suspended. The NG-RAN, the UE, and the AMF need to save the next generation application protocol (NGAP) UE association, UE context, and protocol data unit (PDU) session context-related data required to resume the connection.

In process 102, for the suspended PDU session, the AMF transmits an Nsmf_PDUSession_UpdateSMContext Request message to the corresponding SMF, instructing the SMF to suspend the user plane resources corresponding to the PDU session.

In step 103, the SMF transmits an N4 session modification request to the UPF, instructing the UPF to release the corresponding NG-RAN user plane tunnel information and whether to buffer the receiving downlink data. The UPF returns the execution result to the SMF. The SMF needs to save the N3 tunnel information.

In process 104, the SMF transmits an Nsmf_PDUSession_UpdateSMContext Response to the AMF, returning the execution result.

In process 105, the AMF transmits a suspend response message to the NG-RAN, successfully completing the session suspension initiated by the NG-RAN.

In process 106, the NG-RAN transmits an RRC message to suspend the connection of the UE to the radio resource control (RRC).

### Connection Resume Process Under CM-IDLE State

The connection resume process under the CM-IDLE state is shown in FIG. 2, and the method includes the following processes.

In process 107, the UE transmits an RRC message to trigger the connection resume process and carries a resume identifier (Resume ID) in the RRC message, which is used by the NG-RAN to query the stored UE context.

In process 108, in the case that the UE accesses a new NG-RAN, the new NG-RAN attempts to obtain the UE context from the old NG-RAN.

In process 109, the NG-RAN and the UE synchronize access layer configuration information over RRC messages. The UE enters the CM-CONNECTED state.

In process 110a, in the case that the UE does not change the NG-RAN, then the NG-RAN transmits an N2 resume request message to the AMF to notify the resumption of UE's RRC connection. The N2 session management (SM) message in the N2 resume request message indicates successfully and unsuccessfully resumed PDU sessions.

In process 110b, in the case that the UE changes the NG-RAN, and the new NG-RAN acquires the UE context from the old NG-RAN, then the new NG-RAN transmits an N2 path switch request to the AMF to notify the resumption of UE's RRC connection, and the request carries the new NG-RAN's tunnel information and indicates the successfully and unsuccessfully switched PDU sessions.

In process 111, for successful PDU sessions, the AMF transmits an Nsmf_PDUSession_UpdateSMContext Req message to the SMF, instructing the SMF to resume the corresponding user plane resources.

In process 112, the SMF interacts with the UPF, indicating the AN tunnel information corresponding to the PDU sessions that the UPF needs to resume, as well as whether buffering is required upon receiving downlink data.

In process 113, the SMF transmits an Nsmf_PDUSession_UpdateSMContext Response message to the AMF, which includes new core network (CN) tunnel information and information about PDU sessions that failed to resume.

In processes 114a and 114b, the AMF transmits an N2 resume response message to the NG-RAN, or the AMF transmits an N2 path switch acknowledge to the new NG-RAN, indicating the resumption of PDU sessions or the failure to resume.

In process 115, the NG-RAN transmits an RRC message to the UE, indicating the result of the connection resumption.

The embodiments of the present disclosure is applicable to NTN systems, as shown in FIG. 3.

FIG. 3 illustrates a schematic diagram of an NTN system where the communication satellite is a regenerative forwarding (regenerative payload) satellite. As shown in FIG. 3, the NTN system includes a terminal device 10, a satellite 20, an NTN gateway 30, and a core network device 50.

In the architecture shown in FIG. 3, the functions of the access network device 40 are integrated on the satellite 20, that is, the satellite 20 possesses the functions of the access network device 40. Communication between the terminal device 10 and the satellite 20 are conducted via an air interface (such as the Uu interface). Communication between the satellite 20 and the NTN gateway 30 (typically located on the ground) is conducted via a satellite radio interface (SRI).

In the architecture shown in FIG. 3, taking the uplink transmission as an example, the terminal device 10 transmits an uplink signal to the satellite 20, the satellite 20 forwards the uplink signal to the NTN gateway 30, and the NTN gateway 30 then transmits the uplink signal to the core network device 50. Taking the downlink transmission as an example, a downlink signal from the core network device 50 is transmitted to the NTN gateway 30, the NTN gateway 30 forwards the downlink signal to the satellite 20, and the satellite 20 then forwards the downlink signal to the terminal device 10.

In the network architecture shown in FIG. 3, the access network device 40 is a device for providing wireless communication services to the terminal device 10. A connection is established between the access network device 40 and the terminal device 10, such that communication including signaling and data interaction is achieved over the connection. There may be a plurality of access network devices 40, and two adjacent access network devices 40 wirelessly communicate with each other. The terminal device 10 switches between different access network devices 40, that is, establishes connections with different access network devices 40.

Taking a cellular communication network as an example, the access network device 40 in the cellular communication network is a base station. A base station is an apparatus deployed in the access network to provide wireless communication functionality for the terminal device 10. Base stations include various forms such as macro base stations, micro base stations, relay stations, access points, and the like. In systems using different wireless access technologies, devices with base station functionality have different names. For example, in 5G NR systems, the devices are referred to as gNodeBs or gNBs. As communication technologies evolve, the name “base station” varies depending on actual situations. For ease of description, in the embodiments of the present disclosure, the apparatuses that provide wireless communication functionality for the terminal device 10 are collectively referred to as base stations or access network devices.

In addition, the terminal device 10 involved in the embodiments of the present disclosure includes various devices with wireless communication functionality such as handheld devices, vehicle-mounted devices, wearable devices, computing devices, or other processing devices connected to wireless modems, as well as various forms of UEs, mobile stations (MSs), terminal devices, or the like. For ease of description, in the embodiments of the present disclosure, the devices mentioned above are collectively referred to as terminal devices. In the embodiments of the present disclosure, “UE” is used in some places to represent “terminal devices”.

In addition, taking the 5G NTN system as an example, the NTN system includes a plurality of satellites 20. One satellite 20 covers a certain range of ground areas, providing wireless communication services for the terminal devices 10 within the ground area. In addition, the satellite 20 orbits the earth, and by deploying a plurality of satellites 20, communication coverage for different areas of the earth's surface can be achieved.

In addition, in the embodiments of the present disclosure, the terms “network” and “system” are often used interchangeably, but those skilled in the art can understand their meanings. The technical solutions described in the embodiments of the present disclosure can be applied to long-term evolution (LTE) systems, 5G systems, subsequent evolution systems of 5G NR systems, or other communication systems, which is not limited in the present disclosure.

FIG. 4 is a schematic diagram of a network architecture according to some embodiments of the present disclosure. As shown in FIG. 4, the 5G network architecture released by the 3rd generation partnership project (3GPP) standardization group includes:
terminals, access networks supporting 3GPP technologies (including radio access network, RAN, or AN), UPF network elements, AMF network elements, SMF network elements, policy control function (PCF) network elements, application function (AF) network elements, data network (DN) network elements, network slice selection function (NSSF) network elements, authentication server function (AUSF) network elements, unified data management (UDM) network elements.

Those skilled in the art can understand that the 5G network architecture shown in FIG. 4 does not constitute a limitation on the 5G network architecture. In specific implementations, the 5G network architecture includes more or fewer network elements than shown in the diagram, or combines certain network elements. It should be understood that in FIG. 4, AN or RAN is represented by (R)AN.

Terminals are UEs, handheld terminals, laptop computers, subscriber units, cellular phones, smart phones, wireless data cards, personal digital assistant (PDAs) computers, tablet computers, wireless modems, handheld devices, laptop computers, cordless phones, wireless local loop (WLL) units, machine type communication (MTC) terminals, handheld devices with wireless communication functionality, computing devices, processing devices connected to wireless modems, drones, vehicle-mounted devices, wearable devices, terminals in the Internet of Things, virtual reality devices, terminal devices in the future 5G network, terminals in future-evolved public land mobile networks (PLMNs), or the like.

The access network device is the access device over which terminals wirelessly access to the network architecture. The device is primarily responsible for radio resource management on the air interface side, quality of service (QoS) management, data compression, encryption, or the like, for example, a base station such as a NodeB, an evolved NodeB (eNodeB), a base station in a 5G mobile communication system or a New Radio (NR) communication system, and a base station in a future mobile communication system.

The UPF network element, the AMF network element, the SMF network element, and the PCF network element are network elements of the 3GPP core network (referred to as core network elements). The UPF network element may be referred to as the UPF network element, primarily responsible for the transmission of user data. Other network elements may be referred to as control plane function (CPF) network elements, primarily responsible for identification, authentication, registration management, session management, mobility management, policy control, etc., to ensure the reliable and stable transmission of user data.

The UPF network element is configured to forward and receive data from terminals. For example, the UPF network element receives service data from the data network and transmits the data to terminals over access network devices; the UPF network element also receives user data from terminals over access network devices and forwards the data to the data network. The transmission resources allocated and scheduled by the UPF network element for terminals are managed and controlled by the SMF network element. The bearer between terminals and the UPF network element includes the user plane connection between the UPF network element and access network devices, as well as establishing channels between access network devices and terminals. The user plane connection refers to the QoS flow established for transmitting data between the UPF network element and the access network device.

The AMF network element is configured to manage terminal access to the core network, for example, terminal location updates, network registration, access control, terminal mobility management, terminal attachment and detachment, or the like. The AMF network element also provides the control plane storage resource for the session while providing a service for the session of the terminal, so as to store the session identifier, the SMF network element identifier associated with the session identifier, or the like.

The SMF network element is configured to select user plane network elements for terminals, redirect user plane network elements for terminals, allocate Internet Protocol (IP) addresses to terminals, and establish bearers (also referred to as sessions) between terminals and UPF network elements, modify and release sessions, and control QoS.

The PCF network element is configured to provide policies to the AMF network element and the SMF network element, such as QoS policies, slice selection policies, or the like.

The AF network element is configured to interact with 3GPP core network elements to support the routing of data influenced by applications, access network exposure functions, and interact with the PCF network element for policy control, or the like.

The DN provides data services for users, such as IP multi-media service (IMS) networks, the Internet, or the like. Within the DN, there are various application servers (ASs) providing different application services, such as operator services, internet access, or third-party services. The AS implements the function of the AF.

The NSSF is configured to select network slices, supporting functions such as: selecting a set of network slice instances for UE services; determining permissible network slice selection assistance information (NSSAI) and the mapping to the subscribed single-network slice selection assistance information (S-NSSAI) when needed; determining configured NSSAI and the mapping to subscribed S-NSSAI when needed; and determining AMF sets that may be used for UE queries or determining a list of candidate AMFs based on configuration.

The AUSF is configured to receive identity verification requests for terminals from the AMF, request keys from UDM, and then forward the issued keys to the AMF for authentication processing.

The UDM includes functions such as generating and storing user subscription data and managing authentication data, and supporting interactions with external third-party servers.

The network elements in FIG. 4 are either network components in hardware devices, software functions running on dedicated hardware, or virtualized functions instantiated on platforms (e.g., a cloud platform). It should be noted that in the network architecture illustrated in the above figure, the depicted elements are merely exemplary of the network elements included in the entire network architecture. In the embodiments of the present disclosure, the network elements included in the entire network architecture are not limited.

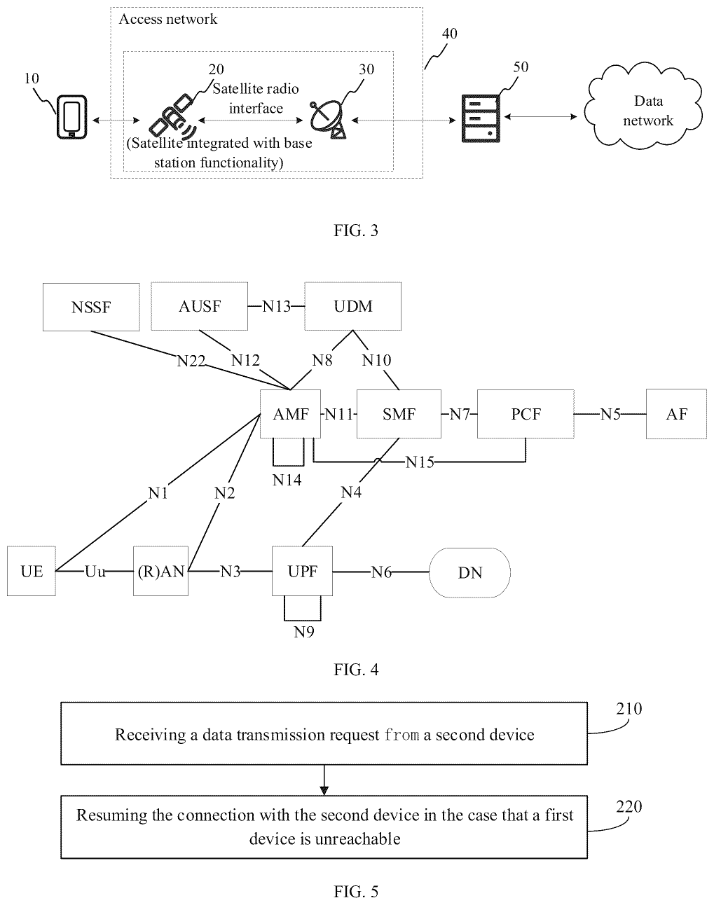

FIG. 5 illustrates a flowchart of a method for transmitting data according to some embodiments of the present disclosure. The embodiments are exemplified by the application of the method to the communication system shown in FIG. 3. The method is applicable to an access network device, which is integrated on a satellite. The method includes the following processes.

In process 210, a data transmission request is received from a second device.

In some embodiments, an access network device receives a data transmission request from the second device, and the data transmission request is configured to request connection resumption. Upon receiving the data transmission request, the access network device determines whether a first device is reachable. In the case that the first device is unreachable, process 220 is performed.

In the case that uplink data transmission is required, the access network device receives a connection resume request from a terminal device. Upon receiving the connection resume request, the access network device determines whether a core network device is reachable.

In the case that downlink data transmission is required, the access network device receives a connection resume message from the core network device. Upon receiving the connection resume message, the access network device determines whether the terminal device is reachable.

In process 220, connection with the second device is resumed in the case that a first device is unreachable.

The first device is a core network device, and the second device is a terminal device.

Alternatively, the first device is a terminal device, and the second device is a core network device.

Where uplink data transmission is required, the access network device, in the case that the core network device is unreachable, performs a connection resume process with the terminal device to resume the RRC connection. That is, the RRC connection is resumed with the terminal device in the case that the core network device is unreachable.

Upon resuming the RRC connection, the access network device receives and buffers the uplink data from the terminal device. Once the core network device enters the coverage range of the satellite, in the case that the terminal device is unreachable, the access network device resumes the N3 connection of the PDU session with the core network device and transmits the uplink data to the core network device.

When downlink data transmission is required, the access network device, in response to determining that the terminal device is unreachable, performs a connection resume process with the core network device to resume the N3 connection of the PDU session. That is, the N3 connection of the PDU session is resumed with the core network device in the case that the terminal device is unreachable.

Upon resumption of the N3 connection of the PDU session, the access network device receives and buffers the downlink data from the core network device. Once the terminal device enters the coverage range of the satellite, in the case that the core network device is unreachable, the access network device resumes the RRC connection with the terminal device and transmits the downlink data to the terminal device.

In summary, according to the technical solutions according to the embodiments of the present disclosure, the satellite, in response to determining that the core network device is unreachable, first resumes the connection with the terminal, transmits uplink data, and buffers the data; the satellite, in response to moving within the coverage range of the core network device, resumes the connection with the core network device and transmits the uplink data to the core network device. The satellite, in response to determining that the terminal device is unreachable, first resumes the connection with the core network device, transmits downlink data, and buffers the data; the satellite, in response to moving to the terminal device, resumes the connection with the terminal device and transmits the downlink data to the terminal device. By employing this method in a satellite communication scenario where the connection between the terminal device and the network cannot always be maintained, the satellite, in the case that one end is unreachable, resumes the connection with the other end. This enables the satellite to buffer and forward data upon resumption of the connection, thereby supporting the satellite store-and-forward scenario by the connection resume process.

In some embodiments, the embodiments of the present disclosure further provide a method for transmitting uplink data.

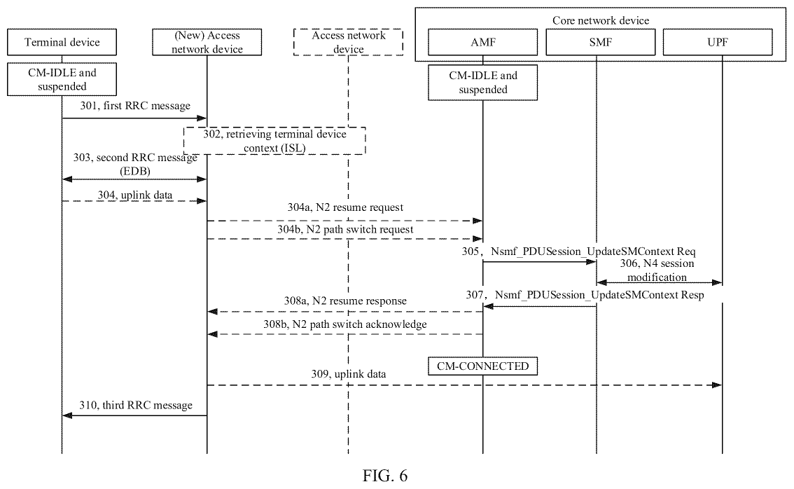

FIG. 6 illustrates a flowchart of a method for transmitting data according to some embodiments of the present disclosure. The embodiments are exemplified by the application of the method to the communication system shown in FIG. 3. The method includes the following processes.

In process 301, in the case that the terminal device is within the coverage range of the access network device, the terminal device transmits a first RRC message to the access network device. The first RRC message is configured to trigger the connection resume process.

The terminal device determines that the terminal device is within the coverage range of the access network device based on the second assistance information; and the second assistance information includes at least one of the ephemeris information, the beam information, the elevation angle, or the reference location.

The ephemeris information includes the satellite ephemeris of the satellite where the access network device is located. Satellite ephemeris, also referred to as a two-line orbital element (TLE), is an expression used to describe the location and velocity of a space object—a two-line orbital data system. The ephemeris information includes at least one of the location or the velocity of the satellite. The beam information includes the cover area (footprint) of the satellite on the ground. The elevation angle is the angle between the tangent line and the connection line of the terminal device. The tangent line is the line tangent to the location of the terminal device relative to the Earth, and the connection line is the line connecting the terminal device to the satellite. The reference location information is the center location of the satellite's cell on the Earth. Based on the second assistance information, the terminal device calculates at least one of the following information: the time when the satellite covers the terminal device, the time when the terminal device establishes a connection with the satellite and the duration, or the time when the satellite establishes a connection with the core network device and the duration.

Based on ephemeris information and other assistance information, the UE knows when there is satellite coverage. Therefore, the UE decides, based on the assistance information, to trigger the connection resume process when the satellite covers the area where the UE is located. The UE transmits a first RRC message to trigger a connection resume process. The first RRC message carries a Resume ID. The Resume ID is used by the RAN to query the stored UE context. That is, the first RRC message includes a resume identifier, which is configured to query the terminal device context of the terminal device.

In some embodiments, prior to process 301, the UE is in the CM-IDLE state and in a connection suspended state.

In process 302, in the case that the UE accesses a new RAN, the new RAN attempts to obtain the UE context from the old RAN.

For example, if the access network device receiving the first RRC message is referred to as the first access network device, then the first access network device, and in the case that the terminal device switches from a second access network device (new access network device) to the first access network device, acquires the terminal device context from the second access network device via the inter-satellite link (ISL).

In process 303, the RAN, upon receiving the first RRC message, determines that the core network device is unreachable and is unable to resume the connection with the core network device. Therefore, the access network device starts the early data buffer (EDB), carrying an EDB indication in the second RRC message transmitted to the UE. The EDB indication instructs the UE to transmit uplink data to the RAN for buffering upon resumption of the RRC connection with the RAN. The RAN determines the buffer time for buffering the uplink data based on UE context, ephemeris information, local configuration, and other assistance information. The RAN synchronizes the access layer configuration information with the UE over RRC messages. The UE enters the CM-CONNECTED state.

That is, the access network device receives the first RRC message from the terminal device. The first RRC message is transmitted by the terminal device in response to determining that the terminal device is within the coverage range of the access network device, and the first RRC message is configured to trigger a connection resume process. The access network device, when determining that the core network device is unreachable, transmits the second RRC message to the terminal device, where the second RRC message carries the EDB indication for instructing the terminal device to transmit uplink data to the access network device for buffering upon resumption of the RRC connection.

The terminal device receives the second RRC message from the access network device, where the second RRC message is transmitted by the access network device in response to determining that the core network device is unreachable.

The access network device determines the buffer time for buffering the uplink data based on the first assistance information. The first assistance information includes at least one of the terminal device context, the ephemeris information, or the local configuration.

In some embodiments, the buffer time includes at least one of the minimum buffer time, the maximum buffer time, and the buffering duration. In some embodiments, the access network device determines the buffer time for uplink data based on the duration required for the satellite to move above the core network device.

In some embodiments, the access network device buffers the uplink data within the time indicated by the buffer time of the uplink data. In some embodiments, the access network device deletes the uplink data after the buffer time for uplink data expires.

The access network device and the terminal device synchronize access layer configuration information over the RRC message to resume the RRC connection.

The terminal device transmits uplink data to the access network device based on the EDB indication. The access network device receives and buffers the uplink data from the terminal device, where the uplink data is the data transmitted to the core network device.

In process 304a, the RAN, based on ephemeris information and other assistance information, knows when it establishes a connection with the AMF. In the case that the UE has not changed the RAN, the RAN transmits an N2 resume request message to the AMF to notify the resumption of UE's RRC connection. The N2 resume request includes an N2 SM message for instructing successfully and unsuccessfully resumed PDU sessions.

The access network device, in the case that the terminal device is unreachable, resumes the N3 connection of the protocol data unit (PDU) session with the core network device.

If the access network device receiving the first RRC message is referred to as the first access network device, then the first access network device, in the case that the core network device is within the coverage range of the first access network device, transmits a resume request message to the core network device (AMF). The resume request message is configured to inform the resumption of the terminal device's RRC connection. The resume request message includes at least one of the identifiers for successfully resumed PDU sessions or the identifiers for unsuccessfully resumed PDU sessions.

In process 304b, in the case that the UE changes the RAN, and the new NG-RAN acquires the UE context from the old RAN via the inter-satellite link, then the new RAN transmits an N2 path switch request to the AMF to notify the resumption of UE's RRC connection, and the request carries the new NG-RAN's tunnel information and indicates the successfully and unsuccessfully switched PDU sessions.

The access network device receiving the first RRC message is referred to as the first access network device, and it is assumed that the terminal device switches from the second access network device to the first access network device, then the first access network device acquires the terminal device context from the second access network device via the inter-satellite link, and transmits a path switch request to the core network device (AMF) based on the terminal device context. The path switch request includes at least one of the tunnel information of the first access network device, identifiers for successfully resumed PDU sessions, or identifiers for unsuccessfully resumed PDU sessions.

In some embodiments, the access network device determines the successfully and unsuccessfully resumed PDU sessions based on the resumption of the RRC connection. The access network device transmits a resume message (either a resume request message or a path switch request) to the core network device. The resume message includes identifiers for successfully and unsuccessfully resumed PDU sessions.

In process 305, for successfully resumed PDU sessions, the AMF transmits an Nsmf_PDUSession_UpdateSMContext Req message to the SMF, instructing the SMF to resume the corresponding user plane resources.

For the successfully resumed PDU sessions indicated in the resume message, the AMF transmits a resume indication to the SMF, instructing the SMF to resume the user plane resources of the part of PDU sessions, and the resume indication includes the PDU session Identifiers for the successfully resumed PDU sessions.

In process 306, the SMF interacts with the UPF, indicating the AN tunnel information corresponding to the PDU sessions that the UPF needs to resume, as well as whether buffering is required upon receiving downlink data.

The SMF instructs the UPF to resume the N3 connection of the PDU sessions based on the PDU session identifiers for successfully resumed PDU sessions in the resume indication.

In process 307, the SMF transmits an Nsmf_PDUSession_UpdateSMContext Response message to the AMF, which includes new CN tunnel information and information about PDU sessions that failed to resume.

In process 308a, in the case that the UE does not change the RAN, the AMF transmits an N2 resume response message to the NG-RAN. In process 308b, in the case that the UE changes the RAN, the AMF transmits an N2 path switch acknowledge message to the new NG-RAN, indicating the resumed PDU sessions or the failure of the resumption.

In process 309, the NG-RAN transmits the buffered uplink data to the UPF.

The access network device transmits the buffered uplink data to the core network device. The uplink data is buffered in the access network device in the case that the access network device cannot reach the core network device. The core network device receives the uplink data from the access network device.

As the NG-RAN is currently unable to connect to the UE, it cannot transmit the RRC message to indicate the result of the connection resumption.

In step 310, the satellite, when flying to the location covering the UE, notifies the UE of the uplink data transmission result via the third RRC message.

For example, the transmission result includes: failure in resuming partial PDU session connections resulting in part of the uplink data not being transmitted successfully.

The access network device, in the case that the terminal device is within the coverage range of the access network device, transmits the third RRC message to the terminal device. The third RRC message is configured to notify the transmission result of the uplink data. The terminal device receives the third RRC message from the access network device.

In summary, according to the technical solutions according to the embodiments of the present disclosure, in the scenario of transmitting uplink data, the UE, upon entering the satellite coverage range, transmits an RRC message to the satellite to request connection resumption. The satellite, in response to determining that the core network device is unreachable, starts the EDB and transmits to the UE an RRC message carrying an EDB indication, instructing the UE to upload uplink data for buffering upon RRC connection resumption. The satellite buffers the uplink data. The satellite, in response to moving to the location covering the core network device, transmits a resume message to the core network device, requesting the resumption of the N3 connection of PDU sessions. Upon resumption of the connection, the satellite transmits the uplink data to the core network device, completing the transmission of the uplink data. By employing this method in a satellite communication scenario where the connection between the terminal device and the network cannot always be maintained, the satellite, in the case that one end is unreachable, resumes the connection with the other end. This enables the satellite to buffer and forward data upon resumption of the connection, thereby supporting the satellite store-and-forward scenario over the connection resume process.

The technical solutions according to the embodiments of the present disclosure offer a method for supporting satellites with storage and forwarding capabilities. In the uplink data transmission, the connection between the UE and the RAN is resumed first in the case that there is no connection to the core network device. The RAN is informed to collect uplink data from the UE using the EDB mode and buffer the data. When connecting to the core network device is possible, the connection with the core network device is resumed then, and the data is transmitted to the UPF in an uplink mode. With the support of satellites with storage and forwarding capabilities, service coverage of UEs in certain specific areas, such as remote sea areas, is achieved.

In some embodiments, the embodiments of the present disclosure further provide a method for transmitting downlink data.

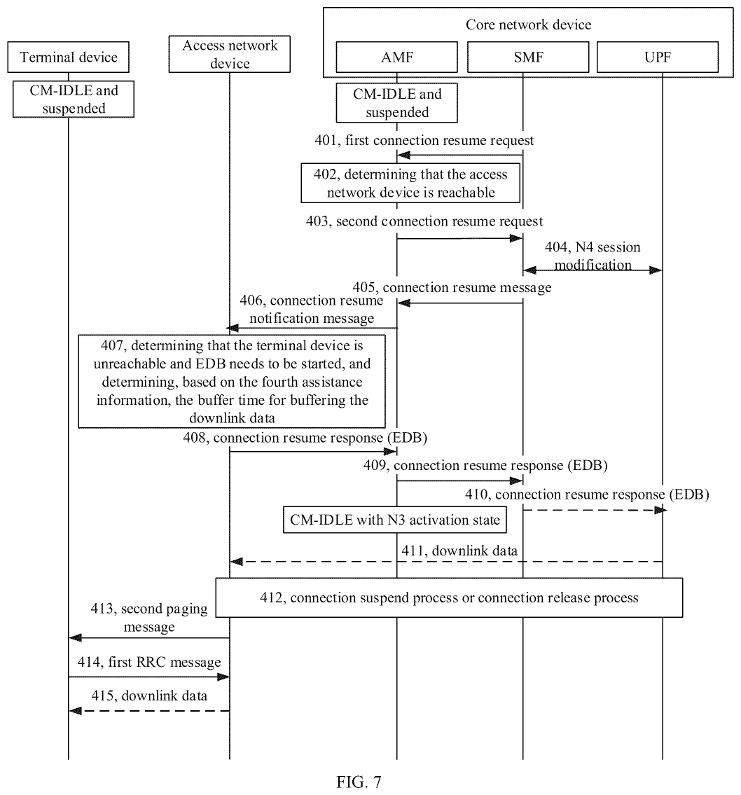

FIG. 7 illustrates a flowchart of a method for transmitting data according to some embodiments of the present disclosure. The embodiment is exemplified by the application of the method to the communication system shown in FIG. 3. The method includes the following processes.

In process 401, for downlink data, since the UE is in the CM-IDLE state and when there is downlink data to be transmitted, the SMF transmits a Namf_Communication_N1N2MessageTransfer message (first connection resume request) to the AMF, requesting the resumption of the N3 connection.

The first connection resume request includes at least one parameter from: the first connection resume request (SUPI), the PDU session identifier (PDU session ID), the N2 session management information (N2 SM information), the QoS flow identifier (QFI(s)), the quality of service profile (QoS profile(s)), the core network N3 tunnel information (CN N3 Tunnel Info), or the single network slice selection assistance information (S-NSSAI).

In some embodiments, the core network device includes the first core network element, the second core network element, and the third core network element. In some embodiments, the first core network element includes the AMF network element, the second core network element includes the SMF network element, and the third core network element includes the UPF network element.

In the case that downlink data needs to be transmitted, the core network device transmits a first connection resume request to the first core network element over the second core network element. The first connection resume request is configured to request the resumption of the N3 connection of the PDU session.

In process 402, the AMF, upon receiving the first connection resume request, determines whether the RAN corresponding to the connection to be resumed is reachable based on the RAN UE NGAP ID of the NG-RAN stored in the mobility management (MM) context.

In the case that downlink data needs to be transmitted, the core network device determines whether the access network device corresponding to the PDU session is reachable over the first core network element.

In some embodiments, in the case that the AMF receives the first connection resume request, the core network device determines whether the access network device corresponding to the PDU session is reachable over the first core network element.

In process 403, in the case that the satellite connects to the AMF, the AMF transmits an Nsmf_PDUSession_UpdateSMContext Req message (the second connection resume request) to the SMF, requesting the SMF to resume the user plane resources.

The second connection resume request includes at least one parameter from: the PDU session ID, the cause, the operation type, the user location information, the age of location information, and the N2 SM information.

In the case that the access network device is reachable, the core network device resumes the N3 connection of the PDU session over the first core network element, the second core network element, and the third core network element. In some embodiments, in the case that the access network device is reachable, the core network device transmits the second connection resume request to the second core network element over the first core network element. The second connection resume request is configured to request the resumption of the N3 connection of the PDU session, and the second connection request includes the PDU session identifier.

In process 404, the SMF interacts with the UPF to resume the user plane resources.

The core network device resumes the N3 connection of the PDU session over the interaction between the second core network element and the third core network element.

In some embodiments, the SMF interacts with the UPF based on the PDU session identifier in the second connection resume request to resume the user plane resources corresponding to the PDU session.

In process 405, the SMF transmits an Nsmf_PDUSession_UpdateSMContext Response message (connection resume message) to the AMF.

The core network device transmits the connection resume message to the first core network element over the second core network element.

In process 406, the AMF transmits a connection resume notification message to the RAN.

The core network device transmits a connection resume notification message to the access network device over the first core network element. The connection resume notification message is configured to notify the access network device that the N3 connection of the PDU session has been resumed.

In process 407, the RAN, upon receiving the connection resume notification message, determines that the UE is unreachable, starts EDB, and based on UE context and assistance parameters, determines the buffer time for buffering the downlink data.

The access network device receives the connection resume notification message from the core network device. The connection resume notification message is transmitted by the core network device upon resumption of the N3 connection of the PDU session in response to determining that the core network device is within the coverage range of the access network device.

In some embodiments, the access network device determines that the terminal device is unreachable based on the third assistance information. The third assistance information includes at least one of the location of the access network device, the ephemeris information, or the location information of the terminal device.

Alternatively, the access network device transmits a first paging message to the terminal device; in the case that no paging response is received from the terminal device within a preset time, it is determined that the terminal device is unreachable.

The access network device determines the buffer time for buffering the downlink data based on the fourth assistance information. The fourth assistance information includes at least one of the context of the terminal device, the ephemeris information, or the local configuration.

In some embodiments, the buffer time includes at least one of the minimum buffer time, the maximum buffer time, or the buffering duration. In some embodiments, the access network device determines the buffer time for downlink data based on the duration required for the satellite to move over the terminal device.

In some embodiments, the access network device buffers the downlink data within the time indicated by the buffer time for downlink data. In some embodiments, the access network device deletes the downlink data after the buffer time for downlink data expires.

In process 408, the RAN transmits a connection resume response to the AMF. The connection resume response carries an EDB indication.

The access network device, when determining that the terminal device is unreachable, transmits a connection resume response to the core network device. The connection resume response includes an EDB indication for instructing the core network device to transmit downlink data to the access network device for buffering.

In process 409, the AMF transmits the connection resume response to the SMF.

The core network device receives the connection resume response from the access network device over the first core network element. The connection resume response is transmitted by the access network device in response to determining that the terminal device is unreachable.

The core network device transmits the connection resume response to the second core network element over the first core network element.

In process 410, the SMF transmits the connection resume response to the UPF.

The core network device transmits the connection resume response to the third core network element over the second core network element.

In process 411, the UPF receives the EDB indication in the connection resume response and transmits the downlink data to the satellite for buffering.

At this point, the AMF still considers the UE to be in the CM-IDLE state or considers the UE to be CM-IDLE with N3 activation indication. The CM-IDLE with N3 activation indication indicates that the UE is in the CM-IDLE state but the N3 user plane connection has been temporarily and successfully established. The AMF does not transition the UE to CM-CONNECTED due to the resumption of the N2/N3 connection.

The core network device, in the case that the access network device cannot reach the terminal device, keeps the terminal device in the CM-IDLE state; or, the core network device, in the case that the access network device cannot reach the terminal device, switches the terminal device to the CM-IDLE with N3 activation state. The CM-IDLE with N3 activation state is configured to indicate that the UE is in the CM-IDLE state and the N3 connection has been successfully established.

The core network device transmits downlink data to the access network device. The access network device receives and buffers the downlink data from the core network device. The downlink data is the data transmitted to the terminal device.

In some embodiments, the core network device, based on the EDB indication in the connection resume response, transmits downlink data to the access network device over the third core network element.

In process 412, the RAN initiates the connection suspend process again when the RAN finishes buffering the downlink data. Alternatively, the UPF initiates the connection release process when the RAN finishes buffering the downlink data. For example, after transmitting all the downlink data, the UPF initiates the connection release process to release the N3 connection, and the AMF/SMF initiates the connection release process to release the N2 connection.

The access network device, upon completion of buffering of the downlink data, transmits a connection suspend message to the core network device. The connection suspend message is configured to trigger the connection suspend process to suspend the N3 connection of the PDU session. The core network device receives the connection suspend message from the access network device. The connection suspend message is transmitted by the access network device upon the completion of buffering of the downlink data, and the connection suspend message is configured to trigger the connection suspend process to suspend the N3 connection of the PDU session; the connection suspend process is executed to suspend the N3 connection of the PDU session.

Alternatively, the core network device, upon completion of transmission of the downlink data, executes the release process of the N3 connection over the third core network element, and executes the release process of the N2 connection over the first core network element or the second core network element.

In process 413, the RAN, in response to moving into the coverage area corresponding to the UE, transmits a second paging message to the UE.

The access network device, in the case that the core network device is unreachable and the terminal device is within the coverage range of the access network device, transmits a second paging message to the terminal device. The terminal device receives the second paging message from the access network device. The second paging message is transmitted by the access network device in response to determining that the core network device is unreachable and the terminal device is within the coverage range of the access network device, and the second paging message is configured to trigger the connection resume process.

The access network device determines that the terminal device is within the coverage range of the access network device based on the second assistance information; the second assistance information includes at least one of the ephemeris information, the beam information, the elevation angle, or the reference location.

In process 414, the terminal device transmits a first RRC message to the access network device. The first RRC message is configured to trigger the connection resume process. The access network device receives the first RRC message from the terminal device. The first RRC message is transmitted by the terminal device in response to the second paging message. The access network device and the terminal device synchronize the access layer configuration information over the RRC message and resume the RRC connection.

In process 415, the access network device transmits the downlink data as buffered to the terminal device. The downlink data is buffered in the access network device in the case that the access network device cannot reach the terminal device. The terminal device receives the downlink data from the access network device.

In summary, according to the technical solutions according to the embodiments of the present disclosure, in the scenario of transmitting downlink data, the SMF transmits a connection resume request to the AMF in the case that downlink data needs to be transmitted, and the AMF determines if the RAN is reachable. In the case that the RAN is reachable, the AMF transmits the connection resume request to the SMF. The SMF interacts with the UPF to resume the N3 connection of the PDU session. The SMF transmits a connection resume message to the AMF, and the AMF transmits a connection resume notification message to the RAN. The RAN, in response to determining that the UE is unreachable, transmits a connection resume response carrying an EDB indication to the AMF. The AMF transmits the connection resume response to the UPF via the SMF. The UPF transmits the downlink data to the RAN based on the EDB indication and buffers the data. In response to moving close to the UE, the RAN transmits a paging message to the UE, resumes the RRC connection with the UE, and transmits the downlink data to the UE. By employing this method in a satellite communication scenario where the connection between the terminal device and the network cannot always be maintained, the satellite, in the case that one end is unreachable, resumes the connection with the other end. This enables the satellite to buffer and forward data upon resumption of the connection, thereby supporting the satellite store-and-forward scenario over the connection resume process.

The technical solutions according to the embodiments of the present disclosure offer a method for supporting satellites with storage and forwarding capabilities. In the downlink data transmission, when the UE is unreachable, the satellite first resumes the connection with the core network device, then buffers the downlink data using the EDB mode, and when flying to the area where the UE is reachable, resumes the connection between the UE and the satellite by paging the UE, thereby transmitting the downlink data to the UE. With the support of satellites with storage and forwarding capabilities, service coverage of UEs in certain specific areas, such as remote sea areas, is achieved.

The following are apparatus embodiments of the present disclosure that may be configured to implement the method embodiments of the present disclosure. For details that are not disclosed in the apparatus embodiments of the present disclosure, reference is made to the method embodiments of the present disclosure.

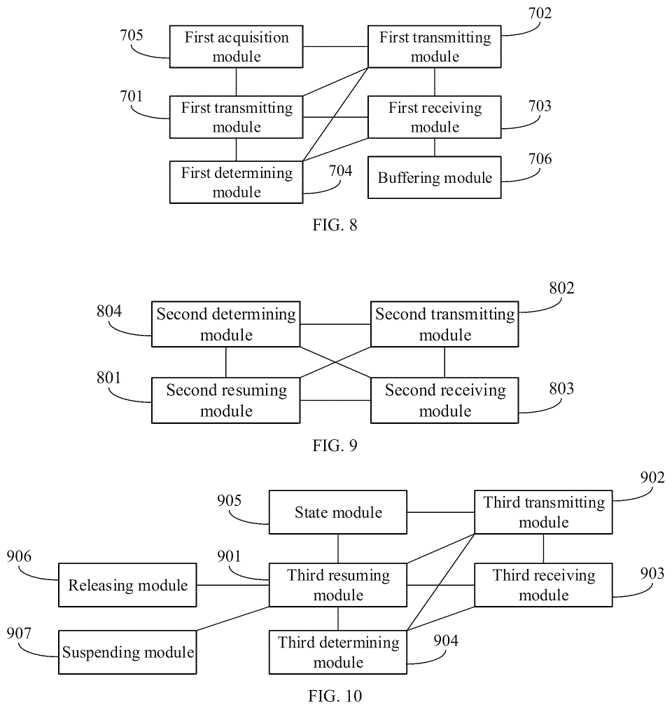

FIG. 8 illustrates a block diagram of an apparatus for transmitting data according to some embodiments of the present disclosure. The apparatus has the function of implementing the method embodiments described above on the access network device side, and the function may be realized by hardware or by hardware executing corresponding software. The apparatus is the access network device mentioned above or is provided within the access network device, which is integrated on a satellite. As shown in FIG. 8, the apparatus includes: a first resuming module 701 configured to resume a connection with a second device in the case that a first device is unreachable; wherein the first device is a terminal device, and the second device is a core network device; or, the first device is a core network device, and the second device is a terminal device.

In some embodiments, the first device is the core network device, and the second device is the terminal device; and the first resuming module 701 is configured to resume an RRC connection with the terminal device in the case that the core network device is unreachable.

In some embodiments, the apparatus further includes: a first receiving module 703 configured to receive a first RRC message from the terminal device, wherein the first RRC message is transmitted by the terminal device in response to determining that the terminal device is within the coverage range of the access network device, and the first RRC message is configured to trigger the connection resume process; and a first transmitting module 702 configured to transmit a second RRC message to the terminal device in the case that the core network device is unreachable, wherein the second RRC message carries an EDB indication for instructing the terminal device to transmit uplink data to the access network device for buffering upon resumption of the RRC connection; wherein the first receiving module 703 and the first transmitting module 702 are configured to resume the RRC connection by synchronizing access layer configuration information with the terminal device over the RRC message.

In some embodiments, the apparatus further includes: a first receiving module 703 configured to receive and buffer uplink data from the terminal device, wherein the uplink data is data transmitted to the core network device.

In some embodiments, the apparatus further includes: a first determining module 704 configured to determine the buffer time for buffering the uplink data based on the first assistance information, wherein the first assistance information includes at least one of the terminal device context, the ephemeris information, or the local configuration.

In some embodiments, the apparatus further includes: a buffering module 706 configured to buffer the uplink data within the time indicated by the buffer time of the uplink data.

In some embodiments, the apparatus further includes: a first transmitting module 702 configured to transmit the uplink data as buffered to the core network device, wherein the uplink data is buffered in the access network device in the case that the access network device determines that the core network device is unreachable.

In some embodiments, the apparatus further includes: a first transmitting module 702 configured to transmit a third RRC message to the terminal device in the case that the terminal device is within a coverage range of the access network device, wherein the third RRC message is configured to notify the transmission result of the uplink data.

In some embodiments, the first device is the terminal device, and the second device is the core network device; and the first resuming module 701 is configured to resume an N3 connection of the protocol data unit (PDU) session with the core network device in the case that the terminal device is unreachable.

In some embodiments, the apparatus further includes: a first receiving module 703 configured to receive a connection resume notification message from the core network device, wherein the connection resume notification message is transmitted, upon resumption of the N3 connection of the PDU session, by the core network device in response to determining that the core network device is within the coverage range of the access network device; wherein the first transmitting module 702 is configured to transmit a connection resume response to the core network device in the case that the terminal device is unreachable. The connection resume response includes an EDB indication for instructing the core network device to transmit downlink data to the access network device for buffering.

In some embodiments, the apparatus further includes: a first receiving module 703 configured to receive and buffer downlink data from the core network device. The downlink data is transmitted to the terminal device.

In some embodiments, the apparatus further includes: a first determining module 704 configured to determine that the terminal device is unreachable based on the third assistance information, wherein the third assistance information includes at least one of the location of the access network device, the ephemeris information, or the location information of the terminal device; or, a first transmitting module 702 configured to transmit a first paging message to the terminal device, and a first determining module 704 configured to determine that the terminal device is unreachable in the case that no paging response is received from the terminal device within a preset time.

In some embodiments, the apparatus further includes: a first determining module 704 configured to determine the buffer time for buffering the downlink data based on the fourth assistance information, wherein the fourth assistance information includes at least one of the terminal device context, the ephemeris information, or the local configuration.

In some embodiments, the apparatus further includes: a buffering module 706 configured to buffer the downlink data within the time indicated by the buffer time of the downlink data. A first transmitting module 702 is configured to transmit a connection suspend message to the core network device upon completion of buffering of the download data, wherein the connection suspend message is configured to trigger the connection suspend process to suspend the N3 connection of the PDU session.

In some embodiments, the apparatus is configured to implement the first access network device. The apparatus further includes: a first acquisition module 705 configured to acquire the terminal device context from the second access network device over the inter-satellite link (ISL) in the case that the terminal device switches from a second access network device to the first access network device.

In some embodiments, the apparatus further includes: a first transmitting module 702 configured to transmit a second paging message to the terminal device in the case that the terminal device is within a coverage range of the access network device; and a first receiving module 703 configured to receive a first RRC message from the terminal device, wherein the first RRC message is transmitted by the terminal device in response to the second paging message, and the first RRC message is configured to trigger the connection resume process; wherein the first transmitting module 702 and the first receiving module 703 are configured to resume the RRC connection by synchronizing access layer configuration information with the terminal device over the RRC message.

In some embodiments, the apparatus further includes: a first transmitting module 702 configured to transmit the downlink data as buffered to the terminal device, wherein the downlink data is buffered in the access network device in the case that the access network device determines that the terminal device is unreachable.

In some embodiments, the apparatus further includes: a first receiving module configured to receive a data transmission request from the second device, wherein the data transmission request is configured to request connection resumption.

FIG. 9 illustrates a block diagram of an apparatus for transmitting data according to some embodiments of the present disclosure. The apparatus has the function of implementing the method embodiments described above on the terminal device side, and the function may be realized by hardware or by hardware executing corresponding software. The apparatus is the terminal device mentioned above or is provided within the terminal device. As shown in FIG. 9, the apparatus includes: a second resuming module 801 configured to resume an RRC connection with an access network device in the case that a core network device is unreachable by the access network device, wherein the access network device is integrated on a satellite.

In some embodiments, the apparatus further includes: a second transmitting module 802 configured to transmit a first RRC message to the access network device in the case that the terminal device is within the coverage range of the access network device, wherein the first RRC message is configured to trigger the connection resume process; and a second receiving module 803 configured to receive a second RRC message from the access network device, wherein the second RRC message is transmitted by the access network device in response to determining that the core network device is unreachable, and the second RRC message carries an EDB indication for instructing the terminal device to transmit uplink data to the access network device for buffering upon resumption of the RRC connection; wherein the second transmitting module 802 and the second receiving module 803 are configured to resume the RRC connection by synchronizing access layer configuration information with the access network device over an RRC message.

In some embodiments, the apparatus further includes: a second transmitting module 802 configured to transmit the uplink data to the access network device based on the EDB indication, wherein the uplink data is transmitted to the core network device.

In some embodiments, the apparatus further includes: a second determining module 804 configured to determine that the terminal device is within the coverage range of the access network device based on second assistance information, wherein the second assistance information includes at least one of the ephemeris information, the beam information, the elevation angle, or the reference location.

In some embodiments, the apparatus further includes: a second receiving module 803 configured to receive a third RRC message from the access network device, wherein the third RRC message is configured to notify the transmission result of the uplink data.

In some embodiments, the apparatus further includes: a second receiving module 803 configured to receive a second paging message from the access network device, wherein the second paging message is transmitted by the access network device in response to determining that the core network device is unreachable and the terminal device is within the coverage range of the access network device; and a second transmitting module 802 configured to transmit a first RRC message to the access network device, wherein the first RRC message is configured to trigger the connection resume process; wherein the second receiving module 803 and the second transmitting module 802 are configured to resume the RRC connection by synchronizing access layer configuration information with the access network device over an RRC message.

In some embodiments, the apparatus further includes: a second receiving module 803 configured to receive downlink data from the access network device, wherein the downlink data is buffered in the access network device in the case that the access network device determines that the terminal device is unreachable, and the downlink data is data transmitted by the core network device to the terminal device.

FIG. 10 illustrates a block diagram of an apparatus for transmitting data according to some embodiments of the present disclosure. The apparatus has the function of implementing the method embodiments described above on the core network device side, and the function may be realized by hardware or by hardware executing corresponding software. The apparatus is the core network device mentioned above or is provided within the core network device. As shown in FIG. 10, the apparatus includes: a third resuming module 901 configured to resume the N3 connection of the PDU session with the access network device in the case that a terminal device is unreachable by the access network device, wherein the access network device is integrated on a satellite.

In some embodiments, the apparatus further includes: a third receiving module 903 configured to receive uplink data from the access network device, wherein the uplink data is buffered in the access network device in the case that the access network device determines that the core network device is unreachable, and the uplink data is transmitted by the terminal device to the core network device.

In some embodiments, the core network device includes a first core network element, a second core network element, and a third core network element; and the apparatus further includes: a third determining module 904 configured to, in the case that downlink data needs to be transmitted, determine whether the access network device corresponding to the PDU session is reachable over the first core network element; the third resuming module 901 configured to resume the N3 connection of the PDU session over the first core network element, the second core network element, and the third core network element in the case that the access network device is reachable; a third transmitting module 902 configured to transmit a connection resume notification message to the access network device over the first core network element, wherein the connection resume notification message is configured to notify the access network device that the N3 connection of the PDU session has been resumed; and a third receiving module 903 configured to receive a connection resume response from the access network device over the first core network element, wherein the connection resume response is transmitted by the access network device in response to determining that the terminal device is unreachable, and the connection resume response includes an EDB indication for instructing the core network device to transmit downlink data to the access network device for buffering.

In some embodiments, the third determining module 904 is configured to, in the case that downlink data needs to be transmitted, transmit a first connection resume request to the first core network element over the second core network element, wherein the first connection resume request is configured to request the resumption of the N3 connection of the PDU session; and the third determining module 904 is configured to, in response to receiving the first connection resume request, determine whether the access network device corresponding to the PDU session is reachable over the first core network element.

In some embodiments, the third resuming module 901 is configured to transmit a second connection resume request to the second core network device over the first core network element in the case that the access network device is reachable, wherein the second connection resume request is configured to request the resumption of the N3 connection of the PDU session; the third resuming module 901 is configured to resume the N3 connection of the PDU session over an interaction between the second core network element and the third core network element; and the third resuming module 901 is configured to transmit a connection resume message to the first core network element over the second core network element.

In some embodiments, the apparatus further includes: a third transmitting module 902 configured to transmit downlink data to the access network device. The downlink data is data transmitted to the terminal device.

In some embodiments, the core network device includes a first core network element, a second core network element, and a third core network element; the third transmitting module 902 is configured to transmit a connection resume response to the second core network element over the first core network element, wherein the connection resume response includes an EDB indication for instructing the core network device to transmit downlink data to the access network device for buffering; the third transmitting module 902 is configured to transmit the connection resume response to the third core network element over the second core network element; and the third transmitting module 902 is configured to transmit the downlink data to the access network device over the third core network element based on the EDB indication in the connection resume response.

In some embodiments, the core network device includes a first core network element, a second core network element, and a third core network element; and the apparatus further includes: a releasing module 906 configured to perform a release process of the N3 connection over the third core network element upon completion of transmission of the downlink data; wherein the releasing module 906 is configured to perform a release process of the N2 connection over the first core network element or the second core network element.

In some embodiments, the apparatus further includes: a third receiving module 903 configured to receive a connection suspend message from the access network device, wherein the connection suspend message is transmitted by the access network device upon completion of buffering of the downlink data, and the connection suspend message is configured to trigger the connection suspend process to suspend the N3 connection of the PDU session; and a suspending module 907 configured to perform the connection suspend process to suspend the N3 connection of the PDU session.

In some embodiments, the apparatus further includes: a state module 905 configured to keep the terminal device in the connection management (CM)-IDLE state in the case that the access network device determines that the terminal device is unreachable; or Alternatively, a state module 905 configured to switch the terminal device to the CM-IDLE with N3 activation state in the case that the access network device determines that the terminal device is unreachable; wherein the CM-IDLE with N3 activation state indicates that the UE is in the CM-IDLE state and the N3 connection has been successfully established.

In some embodiments, the first core network element includes an AMF network element, the second core network element includes an SMF network element, and the third core network element includes a UPF network element.

It should be noted that, in the case that the apparatus according to the above embodiments implements the functions thereof, the division of the functional modules is merely exemplary. In practical application, the above functions may be assigned to different functional modules according to actual needs, i.e., the internal structure of the device may be divided into different functional modules, so as to implement all or a part of the above functions.

With regard to the apparatus in the above embodiments, the specific manner in which each module performs the operation has been described in detail in the embodiments related to the method and will not be described in detail herein.

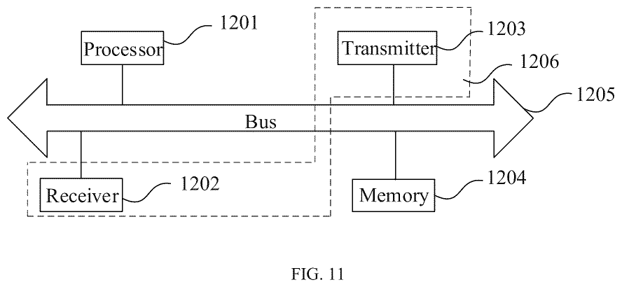

FIG. 11 illustrates a schematic structural diagram of a communication device (terminal device or network device) according to some embodiments of the present disclosure. The communication device includes a processor 1201, a receiver 1202, a transmitter 1203, a memory 1204, and a bus 1205.

The processor 1201 includes one or more processing cores, and the processor 1201 performs various functional applications and data transmission by running software programs and modules.

The receiver 1202 and the transmitter 1203 are implemented as one transceiver 1206, and the transceiver 1206 is one communication chip.

The memory 1204 is connected to the processor 1201 over the bus 1205.

The memory 1204 is configured to store a computer program, and the processor 1201 is configured to run the computer program to implement the various processes performed by the terminal device in the above method embodiments.

Furthermore, the memory 1204 is implemented by any type of transitory or non-transitory storage device, or combination thereof. Transitory or non-transitory storage devices include but are not limited to: a random-access memory (RAM), a read-only memory (ROM), an erasable programmable read-only memory (EPROM), an electrically erasable programmable read-only memory (EEPROM), a flash memory or other solid-state storage devices, a compact disc read-only memory (CD-ROM), a digital video disc (DVD) or other optical storage devices, or a magnetic cassette, a magnetic tape, a magnetic disc storage or other magnetic storage devices.

In the case that the communication device is implemented as an access network device, the processor 1201 described in the embodiments of the present disclosure may execute the processes performed by the access network device in the method as shown in any one of FIGS. 5 to 7, which will not be reiterated here.

In some embodiments, in the case that the communication device is implemented as an access network device, the processor is configured to resume a connection with a second device in the case that a first device is unreachable.

The first device is a terminal device, and the second device is a core network device; or, the first device is a core network device, and the second device is a terminal device.

In some embodiments, in the case that the communication device is implemented as a terminal device, the processor 1201 described in the embodiments of the present disclosure may execute the processes performed by the terminal device in the method as shown in any one of FIGS. 5 to 7, which are not reiterated here.

In some embodiments, in the case that the communication device is implemented as a terminal device, the processor is configured to resume an RRC connection with an access network device in the case that a core network device is unreachable by the access network device, wherein the access network device is integrated on a satellite.

In some embodiments, in the case that the communication device is implemented as a core network device, the processor 1201 described in the embodiments of the present disclosure may execute the processes performed by the core network device in the method as shown in any one of FIGS. 5 to 7, which are not reiterated here.

In some embodiments, in the case that the communication device is implemented as a core network device, the processor is configured to resume an N3 connection of the PDU session with an access network device in the case that a terminal device is unreachable by the access network device, wherein the access network device is integrated on a satellite.

Some embodiments of the present disclosure further provide a computer-readable storage medium storing one or more computer programs. The one or more computer programs, when loaded and run by a processor of a terminal device, cause the processor to perform the method for transmitting data on the terminal device side; or the one or more computer programs, when loaded and run by a processor of an access network device, cause the processor to perform the method for transmitting data on the access network device side; or, the one or more computer programs, when loaded and run by a processor of a core network device, cause the processor to perform the method for transmitting data on the core network device side.

In some embodiments, the computer-readable storage medium includes a ROM, a RAM, a solid state drive (SSD), or an optical disc. Herein, the random-access memory includes a resistance random access memory (ReRAM) and a dynamic random access memory (DRAM).

Some embodiments of the present disclosure further provide a chip including programmable logic circuits and/or program instructions. The chip, when running on a terminal device, is configured to perform the method for transmitting data on the terminal device side; or, the chip, when running on an access network device, is configured to perform the method for transmitting data on the access network device side; or, the chip, when running on a core network device, is configured to perform the method for transmitting data on the core network device side.

Some embodiments of the present disclosure further provide a computer program product or a computer program including one or more computer instructions stored in a computer-readable storage medium. The one or more computer instructions, when read and executed by a processor of a terminal device from the computer-readable storage medium, cause the processor to perform the method for transmitting data on the terminal device side; or, the one or more computer instructions, when read and executed by a processor of an access network device from the computer-readable storage medium, cause the processor to perform the method for transmitting data on the access network device side; or, the one or more computer instructions, when read and executed by a processor of a core network device from the computer-readable storage medium, cause the processor to perform the method for transmitting data on the core network device side.

It should be understood that the “indication” mentioned in the embodiments of the present disclosure may be a direct indication, an indirect indication, or an indication that there is an association. For example, A indicates B, which may mean that A indicates B directly, e.g., B may be acquired by A; or that A indicates B indirectly, e.g., A indicates C by which B may be acquired; or that an association is present between A and B.

In the description of the embodiments of the present disclosure, the term “correspond” may indicate a direct or indirect corresponding relationship between two items, or indicate an associated relationship between the two. It may also indicate relationships such as indicating and being indicated, configuring and being configured, etc.

The mentioned term “a plurality of” herein means two or more. The term “and/or” describes the association relationship of the associated objects, and indicates that three relationships may be present. For example, A and/or B may indicate that: only A is present, both A and B are present, and only B is present. The symbol “/” generally indicates an “or” relationship between the associated objects.

In addition, serial numbers of the processes described herein only show an exemplary possible execution sequence among the processes, and in some other embodiments, the processes may also be executed out of the numbering sequence, for example, two processes with different serial numbers are executed simultaneously, or two processes with different serial numbers are executed in a reverse order to the illustrated sequence, which is not limited in the present disclosure.

Those skilled in the art should appreciate that in the one or more examples mentioned above, the functions described in the embodiments of the present disclosure may be implemented using hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, wherein the communication medium includes any medium that facilitates the transfer of a computer program from one place to another. The storage medium is any available medium that is accessible by a general purpose or special purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. An access network device integrated on a satellite, comprising:
a processor, wherein the processor is configured to resume a connection with a second device in a case that a first device is unreachable;
wherein the first device is a terminal device, and the second device is a core network device, or, the first device is a core network device, and the second device is a terminal device.

2. The access network device according to claim 1, wherein the first device is the core network device, and the second device is the terminal device; and
wherein the processor is further configured to:
resume a radio resource control (RRC) connection with the terminal device in a case that the core network device is unreachable.

3. The access network device according to claim 2, wherein the processor is further configured to:
receive a first RRC message from the terminal device, wherein the first RRC message is transmitted by the terminal device in response to determining that the terminal device is within a coverage range of the access network device, and the first RRC message is configured to trigger a connection resume process;
transmit a second RRC message to the terminal device in the case that the core network device is unreachable, wherein the second RRC message carries an early data buffer (EDB) indication for instructing the terminal device to transmit uplink data to the access network device for buffering upon resumption of the RRC connection; and
resume the RRC connection by synchronizing access layer configuration information with the terminal device over an RRC message.

4. The access network device according to claim 3, wherein the processor is further configured to:
determine a buffer time for buffering the uplink data based on first assistance information, wherein the first assistance information comprises at least one of terminal device context, ephemeris information, or local configuration.

5. The access network device according to claim 2, wherein the processor is further configured to:
transmit uplink data as buffered to the core network device, wherein the uplink data is buffered in the access network device in a case that the access network device determines that the core network device is unreachable.

6. The access network device according to claim 5, wherein the processor is further configured to:
transmit a third RRC message to the terminal device in a case that the terminal device is within a coverage range of the access network device, wherein the third RRC message is configured to notify a transmission result of the uplink data.

7. The access network device according to claim 1, wherein the first device is the terminal device, and the second device is the core network device; and
wherein the processor is further configured to:
resume an N3 connection of a protocol data unit (PDU) session with the core network device in a case that the terminal device is unreachable.

8. The access network device according to claim 7, wherein wherein the processor is further configured to:
receive a connection resume notification message from the core network device, wherein the connection resume notification message is transmitted, upon resumption of the N3 connection of the PDU session, by the core network device in response to determining that the core network device is within a coverage range of the access network device; and
transmit a connection resume response to the core network device in the case that the terminal device is unreachable, wherein the connection resume response comprises an early data buffer (EDB) indication for instructing the core network device to transmit downlink data to the access network device for buffering.

9. The access network device according to claim 7, wherein the processor is further configured to:
determine that the terminal device is unreachable based on third assistance information, wherein the third assistance information comprises at least one of location of the access network device, ephemeris information, or location information of the terminal device; or
transmit a first paging message to the terminal device; and
determine that the terminal device is unreachable in a case that no paging response transmitted by the terminal device is received within a preset time.

10. The access network device according to claim 8, wherein the processor is further configured to:
determine a buffer time for buffering the downlink data based on fourth assistance information, wherein the fourth assistance information comprises at least one of terminal device context, ephemeris information, or local configuration.

11. A terminal device, comprising:
a processor, wherein the processor is configured to resume a radio resource control (RRC) connection with an access network device in a case that a core network device is unreachable by the access network device, wherein the access network device is integrated on a satellite.

12. The terminal device according to claim 11, wherein the processor is further configured to:
transmit a first RRC message to the access network device in a case that the terminal device is within a coverage range of the access network device, wherein the first RRC message is configured to trigger a connection resume process;
receive a second RRC message from the access network device, wherein the second RRC message is transmitted by the access network device in response to determining that the core network device is unreachable, and the second RRC message carries an early data buffer (EDB) indication for instructing the terminal device to transmit uplink data to the access network device for buffering upon resumption of the RRC connection; and
resume the RRC connection by synchronizing access layer configuration information with the access network device over an RRC message.

13. The terminal device according to claim 12, wherein the processor is configured to:
transmit the uplink data to the access network device based on the EDB indication, wherein the uplink data is transmitted to the core network device.

14. The terminal device according to claim 12, wherein the processor is configured to:
determine that the terminal device is within the coverage range of the access network device based on second assistance information;
wherein the second assistance information comprises at least one of ephemeris information, beam information, elevation angle, or reference location.

15. The terminal device according to claim 12, wherein the processor is configured to:
receive a third RRC message from the access network device, wherein the third RRC message is configured to notify a transmission result of the uplink data.

16. The terminal device according to claim 11, wherein the processor is configured to:
receive a second paging message from the access network device, wherein the second paging message is transmitted by the access network device in response to determining that the core network device is unreachable and the terminal device is within a coverage range of the access network device;
transmit a first RRC message to the access network device, wherein the first RRC message is configured to trigger a connection resume process; and
resume the RRC connection by synchronizing access layer configuration information with the access network device over an RRC message.

17. The terminal device according to claim 11, wherein the processor is configured to:
receive downlink data from the access network device, wherein the downlink data is buffered in the access network device in a case that the access network device determines that the terminal device is unreachable, and the downlink data is transmitted by the core network device to the terminal device.

18. A core network device, comprising:
a processor, wherein the processor is configured to resume N3 connection of a protocol data unit (PDU) session with an access network device in a case that a terminal device is unreachable by the access network device, wherein the access network device is integrated on a satellite.

19. The core network device according to claim 18, wherein the processor is further configured to:
receive uplink data from the access network device, wherein the uplink data is buffered in the access network device in a case that the access network device determines that the core network device is unreachable, and the uplink data is transmitted by the terminal device to the core network device.

20. The core network device according to claim 18, wherein:
the core network device comprises a first core network element, a second core network element, and a third core network element; and
the processor is further configured to:
determine, in a case that downlink data needs to be transmitted, whether the access network device corresponding to the PDU session is reachable over the first core network element;
resume the N3 connection of the PDU session over the first core network element, the second core network element, and the third core network element in the case that the access network device is unreachable;
transmit a connection resume notification message to the access network device over the first core network element, wherein the connection resume notification message is configured to notify the access network device that the N3 connection of the PDU session has been resumed; and
receive a connection resume response from the access network device over the first core network element, wherein the connection resume response is transmitted by the access network device in response to determining that the terminal device is unreachable, and the connection resume response comprises an early data buffer (EDB) indication for instructing the core network device to transmit downlink data to the access network device for buffering.
